(19) United States
(12) Patent Application Publication
(10) Pub. No.: US 2025/0166308 A1
(43) Pub. Date: May 22, 2025

(54) TRACKING SYSTEM

(71) Applicant: Lipronext Inc., Niigata (JP)

(72) Inventor: Kenji FUJITA, Niigata-shi (JP)

(21) Appl. No.: 18/950,177

(22) Filed: Nov. 18, 2024

(30) Foreign Application Priority Data
Nov. 21, 2023 (JP) 2023-197694

(51) Int. Cl. G06T 19/00; G06F 3/01; G06F 3/0338; G06Q 30/0601; G06T 13/40

(52) U.S. Cl. CPC G06T 19/00; G06F 3/012; G06F 3/013; G06F 3/0338; G06Q 30/0643; G06T 13/40

(57) ABSTRACT

A tracking system includes a plurality of terminals connected to a network by manipulation by a manipulator and a server connectable to the terminals via the network. A server controller is configured to create an avatar in a virtual space and configured to bring the avatar into action in the virtual space in response to manipulation on a terminal input device, display a plurality of transaction objects in each of spaces in each of a plurality of virtual stores, record an action of the avatar on the transaction objects in the virtual store on a server recorder, and when the avatar moves from a first space to a second space, change display of the transaction objects in the second space in advance on the basis of the action of the avatar in the first space.

### BACKGROUND OF THE INVENTION

The present invention relates to a tracking system.

In recent years, many participants can attend a virtual space called metaverse (registered trademark) created on a network by using mobile terminals or the like (for example, see “VR event ‘Sword Art Online Synthesis—The Period of Alicization Project—’”, [online], KAYAC Inc., [searched on Oct. 12, 2021], see <URL: https://www.kayac.com/service/client/1773> on the Internet).

In the virtual space, a participant can interact with other participants by manipulating a virtual character called an avatar.

### SUMMARY OF THE INVENTION

However, a conventional virtual space is further improvable in a survey on transaction objects of interest to a plurality of manipulators manipulating avatars in the virtual space.

The present invention has been made in view of the above circumstances and has an object to provide a tracking system that facilitates a survey on transaction objects of interest to a plurality of manipulators manipulating avatars in a virtual space.

To achieve the above object, the tracking system according to the present invention includes: a plurality of terminals connected to a network by manipulation by a manipulator; and a server connectable to the plurality of terminals via the network. The server includes a server recorder configured to be able to record data and a server controller configured to create a virtual space on the network on the basis of the data recorded on the server recorder. The terminals each include a terminal input device used for manipulating an avatar corresponding to the manipulator in the virtual space and a terminal controller configured to transmit the manipulation on the terminal input device to the server via the network. The virtual space includes a plurality of virtual stores. Each of the virtual stores includes a plurality of spaces including a first space and a second space. The server controller is configured to create the avatar in the virtual space and configured to bring the avatar into action in the virtual space in response to the manipulation on the terminal input device, display a plurality of transaction objects in each of the spaces in each of the plurality of virtual stores, record an action of the avatar on the transaction objects in the virtual store on the server recorder, and when the avatar moves from the first space to the second space, change display of the transaction objects in the second space in advance on the basis of the action of the avatar in the first space.

In the tracking system according to the present invention, when the avatar moves from the first virtual store to the second virtual store, the server controller is configured to change display of the transaction objects in the second virtual store in advance on the basis of the action of the avatar in the first virtual store.

In the tracking system according to the present invention, the action of the avatar is to approach the transaction objects.

In the tracking system according to the present invention, the action of the avatar is to look at the transaction objects.

In the tracking system according to the present invention, the action of the avatar is to pick up the transaction objects by hand.

In the tracking system according to the present invention, regarding any one of the plurality of transaction objects displayed in the first space, a score when the avatar has approached the transaction objects, a score when the avatar has looked at the transaction objects, and a score when the avatar has picked up the transaction objects by hand, differ from one another, and the server controller calculates a numerical value of interest of the manipulator manipulating the avatar in the transaction objects based on the score on the basis of the action of the avatar on the transaction objects in the first space and calculates a degree of interest of the manipulator in the plurality of transaction objects displayed in the first space.

The tracking system according to the present invention has the above configuration and can therefore facilitate a survey on transaction objects of interest to a plurality of manipulators manipulating avatars in a virtual space.

### BRIEF DESCRIPTION OF DRAWINGS

FIG. 1 is a block diagram conceptually illustrating a tracking system according to a first embodiment.

FIG. 2 is a block diagram conceptually illustrating a server included in the tracking system shown in FIG. 1.

FIG. 3 is a block diagram conceptually illustrating each of a plurality of terminals included in the tracking system shown in FIG. 1.

FIG. 4 conceptually shows a movement of an avatar in a virtual space in the first embodiment.

FIG. 5 is a plan view showing a movement of the avatar in the virtual space.

FIG. 6 shows the avatar holding a product of a transaction object by hand in the virtual space.

FIG. 7 is a plan view of a first space of a first virtual store.

FIG. 8 conceptually shows a movement of the avatar in the virtual space in a second embodiment.

### DESCRIPTION OF EMBODIMENTS

### First Embodiment

Modes for carrying out the present invention (embodiments) will be described below in detail referring to the drawings. The contents described referring to the embodiments below do not limit the present invention. Components described below include components that a person skilled in the art can easily conceive of and are substantially the same components. In addition, configurations described below can be combined as appropriate. Various omissions, replacements, and modifications of the configurations are possible within the gist of the present invention.

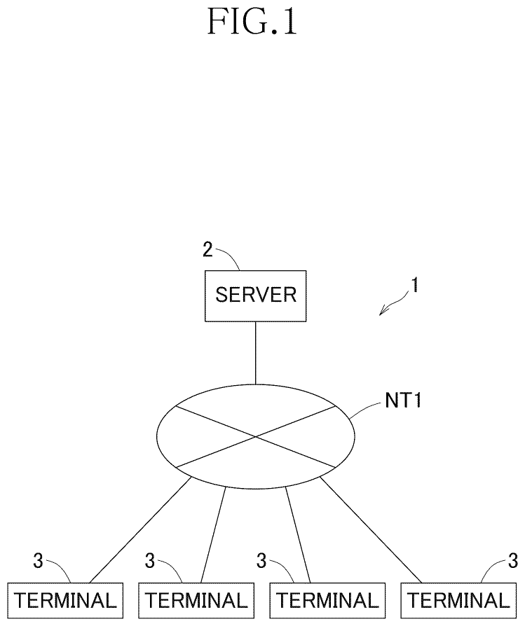

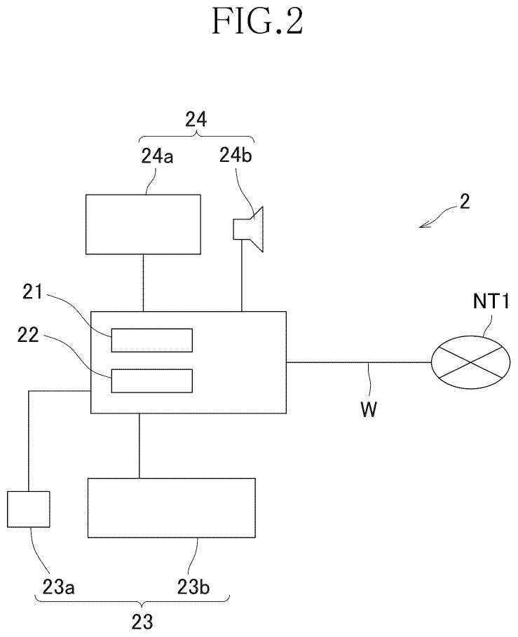

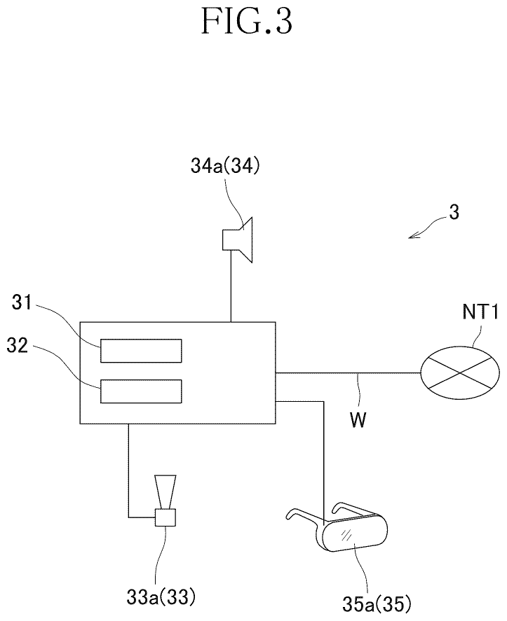

First, the configuration of a tracking system 1 according to a first embodiment will be described below. FIG. 1 is a block diagram conceptually illustrating the tracking system 1 according to the present embodiment. FIG. 2 is a block diagram conceptually illustrating a server 2 included in the tracking system 1 shown in FIG. 1. FIG. 3 is a block diagram conceptually illustrating each of a plurality of terminals 3 included in the tracking system 1 shown in FIG. 1.

As shown in FIG. 1, the tracking system 1 in the present embodiment includes the server 2 and the terminals 3. Each of the terminals 3 is connected to the server 2 via a network (such as the Internet) NT1.

The server 2 is an electronic computer such as a workstation. The server 2 according to the present embodiment is described as a single electronic computer for convenience of description but may be configured by a cloud system that operates by collaboration of a plurality of workstations. The server 2 according to the present embodiment described has a function of providing online shopping services through an electronic commerce site (EC site) and a function of creating a virtual space VS on the network NT1 for convenience of description, but servers 2 having the respective functions may be separately provided.

The server 2 is connected to the network NT1, for example, via a connecting wire W. The server 2 is connected to each of the terminals 3 via the network NT1. The server 2 includes a server controller 21 and a server recorder 22.

The server controller 21 controls each part of the server 2 in an integrated manner. The server controller 21 creates the virtual space VS on the network NT1 on the basis of data recorded on the server recorder 22. More specifically, the server controller 22 creates the virtual space VS that is visually recognizable by respective manipulators of the terminals 3 connectable to the server 2. Further, the server controller 21 creates an avatar (registered trademark) AV in the virtual space VS. As described later, the server controller 21 brings the avatar AV into action in the virtual space VS in response to the manipulation on a terminal input device 33 of the terminal 3. As described later, the server controller 21 tracks the movement of the avatar AV in the virtual space VS and records each movement of the avatar AV for each manipulator on the server recorder 22.

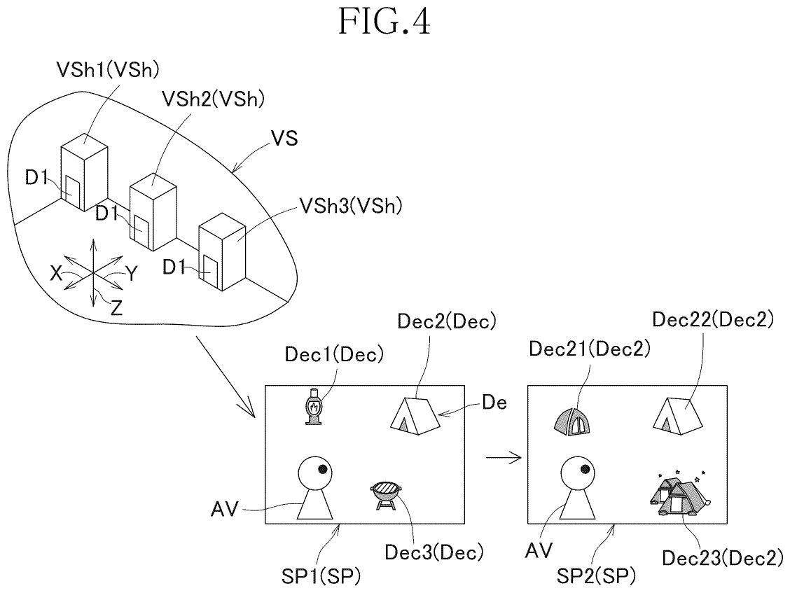

The virtual space VS includes a plurality of virtual stores VSh as shown in FIG. 4. For example, the virtual space VS includes a first virtual store VSh1, a second virtual store VSh2, and a third virtual store VSh3. The virtual store VSh includes a plurality of spaces SP including a first space SP1 and a second space SP2. The virtual space VS according to the present embodiment is, for example, three-dimensional. More specifically, in the virtual space VS shown in FIG. 4, for example, a Z-axis direction as the up-down direction, an X-axis direction as the forward-backward direction, and a Y-axis direction as the right-left direction are orthogonal to one another.

Various data such as a program for operating each part of the server 2 is stored in the server recorder 22. In addition, the server controller 21 can record data on the server recorder 22.

The server 2 includes a server input device 23 such as a mouse 23a and a keyboard 23b and a server output device 24 such as a display 24a and a speaker 24b.

The terminal 3 is, for example, an electronic computer such as a personal computer. Each of the terminals 3 is connected to the network NT1, for example, via a connecting wire W.

The terminal 3 includes a terminal controller 31 and a terminal recorder 32. The terminal controller 31 controls each part of the terminal 3 in an integrated manner. Various data such as a program for operating each part of the terminal 3 is stored in the terminal recorder 32. In addition, the terminal controller 31 can record data on the terminal recorder 32.

The terminal 3 includes, for example, the terminal input device 33 such as a joystick 33a, a terminal output device 34 such as a speaker 34a, and a terminal input-output device 35 such as a wearable device 35a. The wearable device 35a is, for example, a head-mounted display (HMD), smartglasses, or the like. The wearable device 35a is provided with a display, which is an output device, and an eye gaze control device, which is an input device, and constituted, for example, of a three-axis gyroscope sensor.

On the terminal 3, for example, software or an application (hereinafter simply abbreviated to an “app”) of the virtual space VS is downloaded from a website regarding the virtual space VS, and predefined information such as an email address of the manipulator and a credit card number of the manipulator is entered in predefined fields of the website using the terminal input device 33, thereby completing initial registration. After that, when the manipulator operates the app or the like of the virtual space VS on the terminal input device 33, the terminal 3 is connected to the server 2, manipulation of the avatar AV of the manipulator in the virtual space VS is enabled, and the virtual space VS is displayed on the display of the wearable device 35a.

The avatar AV can be manipulated by the manipulator with the terminal input device 33 and serves as the virtual self of the manipulator used in the virtual space VS. The manipulator who operates the terminal 3 is, for example, a user of online shopping services in the virtual stores VSh opened in the virtual space VS.

Next, the relation between operation of the terminal input device 33 and the avatar AV will be described. When the manipulator shifts the lever of the joystick 33a forward, the avatar AV moves forward in the forward-backward direction in the virtual space VS. When the manipulator shifts the lever of the joystick 33a backward, the avatar AV moves backward in the forward-backward direction in the virtual space VS. When the manipulator shifts the lever of the joystick 33a to the right, the avatar AV moves to the right in the right-left direction in the virtual space VS. When the manipulator shifts the lever of the joystick 33a to the left, the avatar AV moves to the left in the right-left direction in the virtual space VS.

Also, when the manipulator shifts the lever in any of the directions while pressing a first button of the joystick 33a, the moving speed of the avatar AV is faster compared to when the manipulator moves the avatar AV by simply shifting the lever in any of the directions.

The tracking system 1 according to the present embodiment has configurations for facilitating a survey on transaction objects of interest to the manipulator manipulating the avatar AV in the virtual space VS. Therefore, those configurations relating to the tracking system 1 will be described below referring to FIG. 4 to FIG. 7.

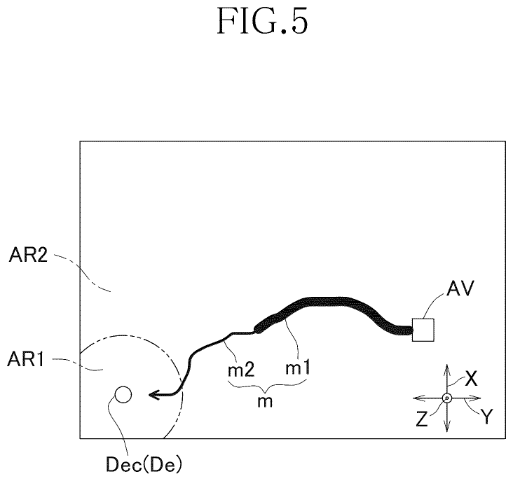

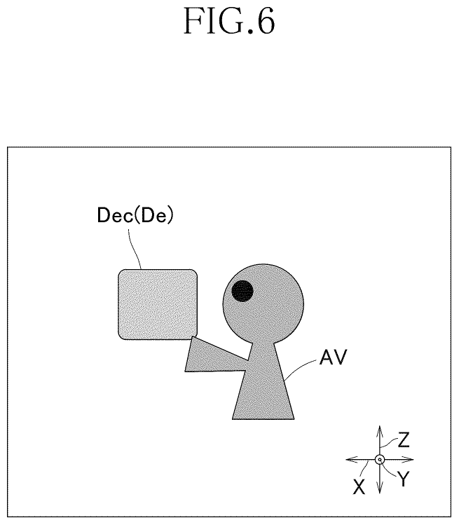

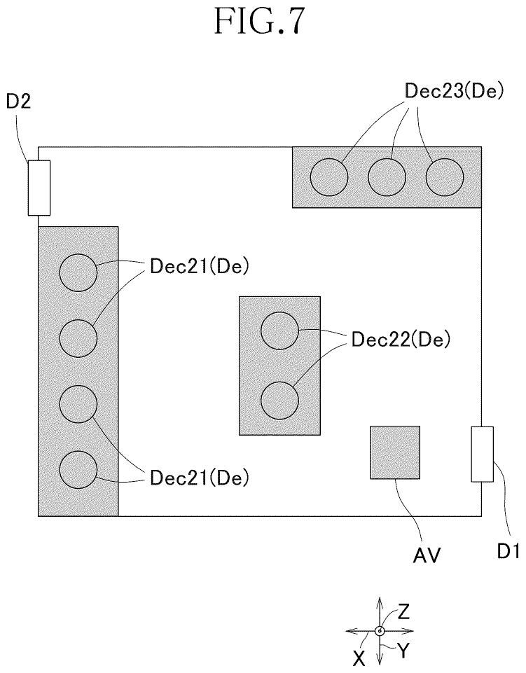

FIG. 4 conceptually shows a movement of the avatar AV in the virtual space VS created on the network NT1 of the tracking system 1 shown in FIG. 1. FIG. 5 is a plan view showing a movement of the avatar AV in the virtual space VS. FIG. 6 shows the avatar AV holding a product of transaction objects De by hand in the virtual space VS. FIG. 7 is a plan view of the first space SP1 of the first virtual store VSh1.

As shown in FIG. 4, in the virtual space VS, a plurality of virtual stores VSh including the first virtual store VSh1, the second virtual store VSh2, and the third virtual store VSh3 are created by the server controller 21. The transaction object De shown in the present embodiment is, for example, a product Dec. In the first space SP1 of the first virtual store VSh1, for example, a lamp as a first transaction object Dec1, a tent as a second transaction object Dec2, and a cooking utensil as a third transaction object Dec3 are displayed.

Each of the virtual stores VSh includes a first door D1 and a second door D2. The first door D1 is a partition between the main body of the virtual space VS and the first space SP1. The second door D2 is a partition between the first space SP1 and the second space SP2. If the manipulator shifts the lever of the joystick 33a forward when the avatar AV is close to the first door D1, the avatar AV enters the inside of the first space SP1 of the first virtual store VSh1.

If the manipulator wearing the wearable device 35a changes (controls) the orientation of the face while the avatar AV is in the first space SP1 of the virtual store VSh, the field of vision of the avatar AV changes. If the transaction object De is located at the center of the display of the wearable device 35a in this case, the server controller 21 judges that the avatar AV has looked at the transaction object De, and records the score of the transaction object De for the avatar AV on the server recorder 22. In the present embodiment, the score when the avatar AV has looked at the transaction object De, is 1.0 point. For example, in the state where the display of the wearable device 35a is divided into 5 sections in the lateral direction and into 3 sections in the vertical direction so as to be divided into 15 sections, if the transaction object De is located at the center of display divided into 15 sections, the server controller 22 judges that the avatar AV has looked at the transaction object De. However, in the tracking system 1 according to the present invention, the judgement by the server controller 21 that the avatar AV has looked at the transaction object De is not limited to this configuration. For example, the terminal input device 33 may be provided with a sensor that detects the pupil of the manipulator to judge where the line of sight is oriented, and the server controller 21 may judge that the avatar AV has looked at the transaction object De on the basis of the detection of the sensor.

In the virtual space VS shown in FIG. 5, in a plan view, a first area AR1 in which the avatar AV is close to the transaction object De and a second area AR2 in which the avatar AV is away from the transaction object De as compared with the first area AR1 are set. In the present embodiment, when the avatar AV has entered the first area AR1 toward the transaction object De, the server controller 21 judges that the avatar AV has approached the transaction object De, and records the score of the target transaction for the avatar AV on the server recorder 22. In the present embodiment, the score when the avatar AV has approached the transaction object De, is 2.0 points.

Also, as shown in FIG. 5, when the avatar AV has entered the first area AR1 from the second area AR2 at an increased speed, the server controller 21 judges that the avatar AV has approached the transaction object De at a high speed, and records the score of the target transaction for the avatar AV on the server recorder 22. In the present embodiment, the score when the avatar AV has approached the transaction object De at a high speed is 2.5 points. The movement of the avatar AV is indicated by the line m in FIG. 5. The bold line m1 indicates the case where the avatar AV has moved at a normal speed, and the thin line m2 indicates the case where the avatar AV has moved at a higher speed than the normal speed.

Further, if the manipulator has pressed a second button of the joystick 33a when the avatar AV is located in the first area AR1 toward the transaction object De, the avatar AV picks up the transaction object De located in the first area AR1 of the avatar AV by hand as shown in FIG. 6. In the present embodiment, when the avatar AV has picked up the transaction object De by hand, the server controller 21 judges that the avatar AV has picked up the transaction object De by hand, and records the score of the target transaction for the avatar AV on the server recorder 22. In the present embodiment, the score when the avatar AV has picked up the transaction object De by hand, is 3.0 points. However, in the tracking system 1 according to the present invention, the judgement by the server controller 21 that the avatar AV has picked up the transaction object Deby hand is not limited to this configuration. For example, in the case where the wearable device 35a can recognize the hand of the avatar AV appearing on the display, when the fingertips of the avatar AV has overlapped the transaction object De, the server controller 21 may judge that the avatar AV has picked up the transaction object Deby hand.

Then, if the manipulator shifts the lever of the joystick 33a forward in this state, the avatar AV moves the transaction object De upward in the up-down direction. If the manipulator shifts the lever of the joystick 33a backward in this state, the avatar AV moves the transaction object De downward in the up-down direction. If the manipulator shifts the lever of the joystick 33a to the right in this state, the avatar AV rotates the transaction object De to the right. If the manipulator shifts the lever of the joystick 33a to the left in this state, the avatar AV rotates the transaction object De to the left. That is, the manipulator can watch the transaction object De by shifting the lever of the joystick 33a in any of the directions while the avatar AV is holding the transaction object Deby hand. Also, in the case where the wearable device 35a can recognize the hand of the avatar AV appearing on the display, the manipulator moves the hand of the avatar AV as if actually holding the transaction object De by hand, and can watch the transaction object De.

Then, if the manipulator has pressed a third button of the joystick 33a while the avatar AV is holding the transaction object Deby hand, the transaction object De is ready for a purchase by the manipulator of the terminal 3 (for example, a product of an actual store corresponding to the transaction object Dein the virtual store VSh is added to the cart).

On the other hand, if the manipulator has pressed a fourth button of the joystick 33a while the avatar AV is holding the transaction object Deby hand, the avatar AV releases the transaction object De, and movement of the avatar AV in the first space SP1 becomes possible.

The server controller 21 deems the total points of the score of looking at each transaction object De, the score of approaching the target transaction, and the score of picking up the transaction object De by hand to be the numerical value of interest of the manipulator for each avatar AV. Then, the server controller 21 calculates the degree of interest of the manipulator based on the number of the total points for each of a plurality of transaction objects De displayed in the first space SP1. More specifically, the server controller 21 decides that one of the transaction objects De having the largest total points is of most interest to the manipulator. The server controller 21 calculates the degree of interest of the manipulator based on the number of the total points for a plurality of the transaction objects De displayed in the first space SP1. Hereinafter this description will be omitted.

In this state, if the manipulator shifts the lever of the joystick 33a forward when the avatar AV is close to the second door D2 inside the first space SP1 of the first virtual store VSh1 shown in FIG. 7, the avatar AV enters the inside of the second space SP2 from the inside of the first space SP1.

Suppose that the transaction object De having the largest total points in the first space SP1 is a tent as the second transaction object Dec2. In this case, the server controller 21 changes the transaction objects De to be displayed in the second space SP2 to a plurality of tents when the avatar AV moves from the first space SP1 to the second space SP2. More specifically, the server controller 21 changes the objects to be displayed in the second space SP2 to, for example, a first tent Dec21, a second tent Dec22, and a third tent Dec23 which are different from one another in shape. That is, the server controller 21 of the tracking system 1 according to the present embodiment changes the transaction objects De to be displayed in the second space SP2 in advance on the basis of the action of the avatar AV in the first space SP1 when the avatar AV moves from the first space

SP1 to the second space SP2.

As described above, the tracking system 1 according to the present embodiment includes the terminals 3 connected to the network NT1 by manipulation by the manipulator and the server 2 connectable to the terminals 3 via the network NT1. The server 2 includes the server recorder 22 configured to be able to record data and the server controller 21 configured to create the virtual space VS on the network NT1 on the basis of the data recorded on the server recorder 22. The terminals 3 each include the terminal input device 33 used for manipulating the avatar AV corresponding to the manipulator in the virtual space VS and the terminal controller 31 configured to transmit the manipulation on the terminal input device 33 to the server 2 via the network NT1. The virtual space VS includes the virtual stores VSh. Each of the virtual stores VSh includes a plurality of spaces including the first space SP1 and the second space SP2. The server controller 21 creates the avatar AV in the virtual space VS and allows the avatar AV to act in the virtual space VS in response to the manipulation on the terminal input device 33. The server controller 21 displays a plurality of transaction objects De in each of the spaces of each of the virtual stores VSh. The server controller 21 records the action of the avatar AV on the transaction object De in the virtual store VSh on the server recorder 22. The server controller 21 changes the display of the transaction objects De in the second space SP2 in advance on the basis of the action of the avatar AV in the first space SP1 when the avatar AV moves from the first space SP1 to the second space SP2, which enables the manipulator to watch the transaction objects De of their interest. In addition, the tracking system 1 according to the present embodiment can facilitate a survey on transaction objects of interest to a plurality of manipulators manipulating the avatars AV in the virtual space VS.

In the tracking system 1, the server controller 21 changes the display of the transaction objects De in the space SP of the second virtual store VSh2 in advance on the basis of the action of the avatar AV in the first virtual store VSh1 when the avatar AV moves from the first virtual store VSh1 to the second virtual store VSh2.

In the tracking system 1 according to the present embodiment, the action by the avatar AV is to approach the transaction objects De.

In the tracking system 1 according to the present embodiment, the action by the avatar AV is to look at the transaction objects De.

In the tracking system 1 according to the present embodiment, the action by the avatar AV is to pick up the transaction objects De by hand.

In the tracking system 1 according to the present embodiment, regarding any one of the transaction objects De displayed in the first space SP1, the score when the avatar AV has approached the transaction object De, the score when the avatar AV has looked at the transaction object De, and the score when the avatar AV has picked up the transaction object De by hand differ from one another. The server controller 21 calculates the numerical value of interest of the manipulator manipulating the avatar AV in the transaction object De based on the score on the basis of the action by the avatar AV on the transaction object De in the first space SP1 and calculates the level of interest of the manipulator in a plurality of transaction objects De displayed in the first space SP1.

Further, in the server 2, the server controller 21 may perform display on the display 24a of the server output device 24 as described below on the basis of data of a plurality of manipulators recorded on the server recorder 22. That is, on the display 24a of the server output device 24, the server controller 21 displays a transaction object De of interest to many manipulators by red, a transaction object De of interest to a few manipulators by blue, and a transaction object De of interest to manipulators in number between many and a few by yellow. In this manner, displaying the transaction objects De by different colors according to the number of manipulators, enables a survey on objects of interest to a plurality of manipulators to be made and reflected in a new product development.

In the tracking system 1 according to the first embodiment described above, the scores for the respective actions of the avatar can be changed as appropriate.

Further, in the tracking system 1 according to the first embodiment described above, the transaction objects De to be displayed are changed in response to the interest of the manipulator. However, the tracking system 1 according to the present embodiment is not limited to this configuration. For example, recommended products may be displayed in response to the interest of the manipulator.

### Second Embodiment

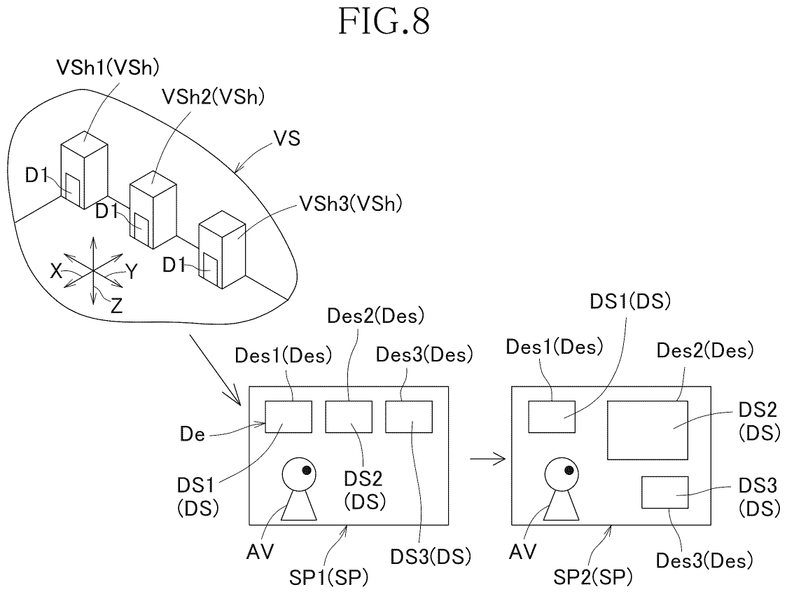

Next, a second embodiment of the tracking system 1 according to the present invention will be described referring to FIG. 8. FIG. 8 conceptually shows a movement of the avatar AV in the virtual space VS created on the network NT1 of the tracking system 1 according to the second embodiment.

In the tracking system 1 according to the second embodiment below, the configurations different from those of the tracking system 1 according to the first embodiment will be described, and the description of the same configuration will be omitted.

The transaction objects De shown in the present embodiment are, for example, services Des. In the first space SP1 of the first virtual store VSh1, for example, information on restaurant where food and drink service is provided is displayed as a first transaction object Des1, information on domestic travel is displayed as a second transaction object Des2, and information on overseas travel is displayed as a third transaction object Des3.

Suppose that the transaction object De having the largest total points in the first space SP1 is the information on domestic travel as the second transaction object Des2. In this case, when the avatar AV moves from the first space SP1 to the second space SP2, the server controller 21 changes the objection sizes in the second space SP2 to enlarge a virtual display DS2 of the second transaction object Des2 than a virtual display DS1 of the first transaction object Des1 and a virtual display DS3 of the third transaction object Des3. That is, the virtual display DS of the transaction object De that is of most interest to the manipulator is displayed in the largest size. Therefore, the server controller 21 of the tracking system 1 according to the present embodiment changes the display of the transaction objects De in the second space SP2 in advance on the basis of the action of the avatar AV in the first space SP1 when the avatar AV moves from the first space SP1 to the second space SP2.

The terminal 3 of the tracking system 1 according to the first embodiment and the second embodiment described above is an electronic computer such as a personal computer. However, the terminal 3 according to the present embodiment is not limited to the above but may be, for example, a smartphone.

1. A tracking system comprising:
a plurality of terminals connected to a network by manipulation by a manipulator; and
a server connectable to the plurality of terminals via the network, wherein
the server includes a server recorder configured to be able to record data and a server controller configured to create a virtual space on the network based on the data recorded on the server recorder,
the terminals each include a terminal input device used for manipulating an avatar corresponding to the manipulator in the virtual space and a terminal controller configured to transmit the manipulation on the terminal input device to the server via the network,
the virtual space includes a plurality of virtual stores,
each of the virtual stores includes a plurality of spaces including a first space and a second space,
the server controller is configured to:
create the avatar in the virtual space and bring the avatar into action in the virtual space in response to the manipulation on the terminal input device;
display a plurality of transaction objects in each of the spaces of each of the plurality of virtual stores;
record an action of the avatar on the transaction objects in the virtual store on the server recorder; and
when the avatar moves from the first space to the second space, change display of the transaction objects in the second space in advance on the basis of the action of the avatar in the first space.

2. The tracking system according to claim 1, wherein, when the avatar moves from the first virtual store to the second virtual store, the server controller is configured to change display of the transaction objects in the second virtual store in advance based on the action of the avatar in the first virtual store.

3. The tracking system according to claim 1, wherein the action of the avatar is to approach the transaction objects.

4. The tracking system according to claim 1, wherein the action of the avatar is to look at the transaction objects.

5. The tracking system according to claim 1, wherein the action of the avatar is to pick up the transaction objects by hand.

6. The tracking system according to claim 1, wherein regarding any one of the plurality of transaction objects displayed in the first space,
a score when the avatar has approached the transaction object,
a score when the avatar has looked at the transaction object, and
a score when the avatar has picked up the transaction object by hand differ from one another, and
the server controller is configured to:
calculate a numerical value of interest of the manipulator manipulating the avatar in the transaction object based on the score on the basis of the action of the avatar on the transaction object in the first space; and
calculate a degree of interest of the manipulator in the plurality of transaction objects displayed in the first space.
